(19) United States
(12) Patent Application Publication
(10) Pub. No.: US 2009/0091515 A1
(43) Pub. Date: Apr. 9, 2009

(54) PLASMA DISPLAY APPARATUS AND RELATED TECHNOLOGIES

(75) Inventors: Yongsin KIM, Seoul (KR); Junghoan KIM, Seoul (KR); Kwangseon LEE, Seoul (KR); Inyoung LEE, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/029,977

(22) Filed: Feb. 12, 2008

(30) Foreign Application Priority Data
Oct. 5, 2007 (KR) 10-2007-0100509

(51) Int. Cl. G09G 3/28

(52) U.S. Cl. 345/60

(57) ABSTRACT

A plasma display apparatus includes a plasma display panel having a screen on which the plasma display panel displays an image, a driver unit that supplies at least one drive signal to the plasma display panel, and a control unit that monitors an input signal to the plasma display apparatus and controls the driver unit based on the monitored input signal. The input signal includes data arranged in frames. The control unit is configured to provide the driver unit with a drive modification signal when the input signal for multiple frames is such that a brightness level for an image corresponding to each of the frames is less than a threshold level. The driver unit is configured to adjust the drive signal supplied to the plasma display panel in response to the drive modification signal.

This nonprovisional application claims priority under 35 U.S.C. §119(a) to Korean Patent Application No. 2007-0100509 filed on Oct. 5, 2007, the entire contents of which are hereby incorporated by reference.

### BACKGROUND

1. Technical Field

This document relates to a plasma display apparatus and related technologies.

2. Description of Related Art

In general, in a plasma display panel, barrier ribs formed between a front panel and a rear panel constitute a unit discharge cell, and inert gas containing main discharge gas such as Neon (Ne), Helium (He), or mixing gas (Ne+He) of Neon and Helium and a small quantity of xenon is filled in each cell. Unit discharge cells constitutes a pixel. For example, a combination of a red color (R) cell, a green color (G) cell, and a blue color (B) cell constitutes a pixel. When a discharge is performed by applying a high frequency voltage in the unit discharge cell, the inert gas generates vacuum ultraviolet rays and allows a phosphor formed between the barrier ribs to emit light and thus an image is displayed. Such a plasma display panel can be thin and lightweight, which makes it appropriate for the next generation display device.

### SUMMARY

In one general aspect, a plasma display apparatus includes a plasma display panel having a screen on which the plasma display panel displays an image, a driver unit that supplies at least one drive signal to the plasma display panel, and a control unit that monitors an input signal to the plasma display apparatus and controls the driver unit based on the monitored input signal. The input signal includes data arranged in frames. The control unit is configured to provide the driver unit with a drive modification signal when the input signal for multiple frames is such that a brightness level for an image corresponding to each of the frames is less than a threshold level. The driver unit is configured to adjust the drive signal supplied to the plasma display panel in response to the drive modification signal.

In another general aspect, a method of driving a plasma display panel that displays an image in response to at least one drive signal supplied to the plasma display panel, includes receiving an input signal for multiple frames, and adjusting the drive signal when the input signal for the multiple frames is such that a brightness level for an image corresponding to each of the plurality of frames is less than a threshold level.

Implementations may include one or more of the following features. For example, the multiple frames may include a number of frames having a combined duration of 5 seconds or more. The multiple frames may be consecutive frames. The plasma display panel may include at least one scan electrode, at least one sustain electrode and at least one address electrode. Each of the frames may include multiple subfields, each of which includes a reset period, an address period and a sustain period. The driver unit may be configured to adjust a number of subfields of a frame in response to the drive modification signal. For example, the driver unit may be configured to reduce the number of subfields of a frame in response to the drive modification signal. The driver unit may be configured to adjust the drive signal in response to the drive modification signal so that at least one of the subfields includes an address period during which a scan pulse is not supplied to the at least one scan electrode.

The driver unit may be configured to adjust a number of sustain pulses supplied to the at least one sustain electrode or the at least one scan electrode during a sustain period of at least one subfield in response to the drive modification signal. For example, the driver unit may be configured to reduce a number of sustain pulses supplied to the at least one sustain electrode or the at least one scan electrode during a sustain period of at least one subfield in response to the drive modification signal.

Additionally or alternatively, the driver unit may be configured to adjust a reset pulse supplied to the at least one scan electrode during a reset period of at least one subfield in response to the drive modification signal. For example, the driver unit may be configured to adjust the highest voltage, e.g., decrease the highest voltage, of the reset pulse supplied to the at least one scan electrode during the reset period of the at least one subfield in response to the drive modification signal. Additionally or alternatively, the driver unit may be configured to adjust the lowest voltage, e.g., increase the lowed voltage, of the reset pulse supplied to the at least one scan electrode during the reset period of the at least one subfield in response to the drive modification signal. Additionally or alternatively, the driver unit may be configured to adjust a time duration of the reset period of the at least one subfield in response to the drive modification signal.

A brightness level for an image corresponding to a frame may be less than the threshold level when an average brightness of all pixels of the frame is less than a first threshold. The first threshold may be 10% of a highest possible brightness of a pixel. Additionally or alternatively, the brightness level for an image corresponding to a frame is less than the threshold level when a number of pixels in the frame having a brightness value greater than a second threshold is less than a third threshold.

The plasma display panel may include sustain electrodes, which are divided into sustain electrode groups, or scan electrodes, which are divided into scan electrode groups. During a predetermined first period of an address period, a first sustain bias voltage may be applied to sustain electrodes of a first sustain electrode group and a second sustain bias voltage different from the first sustain bias voltage may be applied to sustain electrodes of a second sustain electrode group. Alternatively, during the predetermined first period of the address period, a first scan bias voltage may be applied to scan electrodes of a first scan electrode group and a second scan bias voltage different from the first scan bias voltage may be applied to scan electrodes of a second scan electrode group.

Other features will be apparent from the following description, including the drawings, and the claims.

### BRIEF DESCRIPTION OF THE DRAWINGS

FIG. 1 is a block diagram illustrating an example configuration of a plasma display apparatus;

FIG. 2 is a perspective view illustrating an example structure of a plasma display panel;

FIG. 3 is a diagram illustrating an example frame structure for expressing a gray level;

FIG. 4 is a diagram illustrating an example of drive signals to drive a plasma display panel;

FIG. 5 is a flowchart illustrating an example method of driving a plasma display panel;

FIG. 6 is a diagram illustrating an example of frame structures;

FIG. 7 is a diagram illustrating an example scan pulse;

FIG. 8 is a diagram illustrating another example of frame structures.

FIG. 9 is a diagram illustrating examples of driving signals during a subfield;

FIG. 10 is a diagram illustrating an example of reset pulses;

FIG. 11 is a diagram illustrating another example of reset pulses;

FIG. 12 is a diagram illustrating another example of reset pulses;

FIG. 13 is a diagram illustrating another example of reset pulses;

FIG. 14 shows an example waveform for driving a plasma display panel; and

FIG. 15 shows another example waveform for driving a plasma display panel.

### DETAILED DESCRIPTION

Hereinafter, an implementation of this document will be described in detail with reference to the attached drawings.

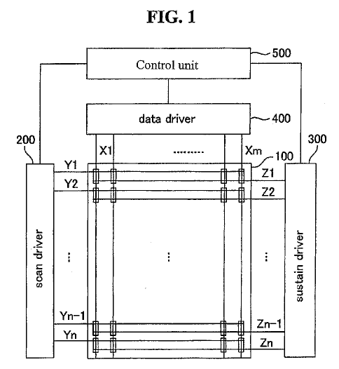

FIG. 1 is a block diagram illustrating an example configuration of a plasma display apparatus.

Referring to FIG. 1, the plasma display apparatus includes a plasma display panel 100 comprising an electrode, a scan driver 200, a sustain driver 300, a data driver 400, and a control unit 500.

In the plasma display panel 100, a front panel (not shown) and a rear panel (not shown) are coupled to each other with a discharge space therebetween. The plasma display panel 100 includes scan electrodes (Y1 to Yn), sustain electrodes (Z1 to Zn), and address electrodes (X1 to Xm).

The scan driver 200 supplies a reset pulse to the scan electrodes (Y1 to Yn) so that wall charges may be uniformly formed within a discharge cell. The scan driver 200 supplies a scan pulse for selecting a discharge cell to generate a discharge in an address period, and a sustain pulse to the scan electrodes (Y1 to Yn) in order to generate a sustain discharge in the selected discharge cell in a sustain period.

The sustain driver 300 supplies a sustain bias pulse to the sustain electrodes (Z1 to Zn) during a set-down period and an address period, and a sustain pulse to the sustain electrodes (Z1 to Zn) during a sustain period.

The data driver 400 supplies a data pulse to the address electrodes (X1 to Xm) during an address period in response to a data timing control signal CTRX from a timing controller (not shown).

The control unit 500 monitors an input signal to the plasma display apparatus. The control unit is configured to provide one or more of the drivers 200, 300 and 400 with a drive modification signal when the input signal for more than one frames is such that a brightness level for an image corresponding to each of the more than one frames is less than a threshold level. A brightness level for an image corresponding to a frame is less than the threshold level when an average brightness of all pixels of the frame is less than a first threshold, for example, 10% of a highest possible brightness of a pixel. Alternatively or additionally, a brightness level for an image corresponding to a frame is less than the threshold level when a number of pixels in the frame having a brightness value greater than a second threshold is less than a third threshold (for example, when less that 20% of the pixels have a brightness value exceeding the second threshold).

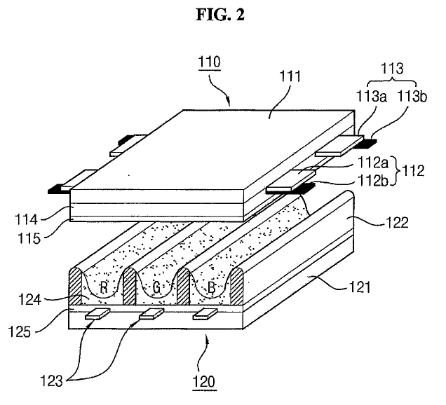

FIG. 2 is a perspective view illustrating an example structure of a plasma display panel.

Referring to FIG. 2, the plasma display panel is formed by coupling a front panel 110 including a front substrate 111 in which a scan electrode 112 and a sustain electrode 113 are formed and a rear panel 120 including a rear substrate 121 in which an address electrode 123 intersecting the scan electrode 112 and the sustain electrode 113 is formed.

The scan electrode 112 and the sustain electrode 113 formed on the front substrate 111 are formed in parallel, thereby generating and sustaining a discharge in a discharge cell.

The scan electrode 112 and the sustain electrode 113 formed on the front substrate 111 generate a discharge within a discharge cell to emit light. For driving efficiency, light transmittance and electrical conductivity are important and, therefore, the scan electrode 112 and the sustain electrode 113 include bus electrodes 112b and 113b made of a metal material such as silver (Ag) and transparent electrodes 112a and 113a made of a transparent indium tin oxide (ITO) material, respectively.

An upper dielectric layer 114 is formed on the front substrate 111 to cover the scan electrode 112 and the sustain electrode 113. The upper dielectric layer 114 insulates the scan electrode 112 and the sustain electrode 113 from each other.

A protection layer 115 for facilitating a discharge condition is formed on the upper dielectric layer 114. The protection layer 115 is made of a material having a high secondary electron emission coefficient, for example, magnesium oxide (MgO).

The address electrode 123 formed on the rear substrate 121 supplies a data pulse to the discharge cell. A lower dielectric layer 125 is formed on the rear substrate 121 to cover the address electrode 123.

A barrier rib 122 for partitioning a discharge space, for example, a discharge cell, is formed on the lower dielectric layer 125. A phosphor layer 124 for emitting visible light for displaying an image is formed within a discharge cell partitioned by the barrier rib 122. For example, a red color (R) phosphor layer, a green color (G) phosphor layer, and a blue color (B) phosphor layer can be formed.

As described above, in the example plasma display panel, when a drive pulse is supplied to the scan electrode 112, the sustain electrode 113, and the address electrode 123, a discharge is generated within a discharge cell partitioned by the barrier rib 122, whereby an image is embodied.

Plasma display panel structures other than shown in FIG. 2 may be used.

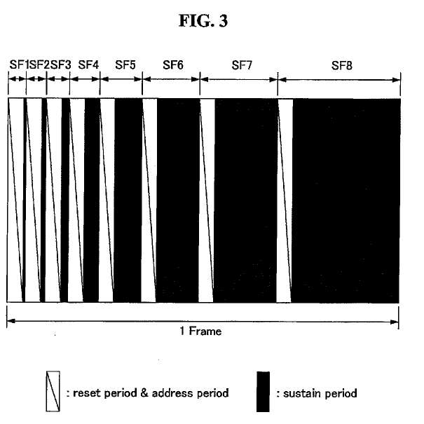

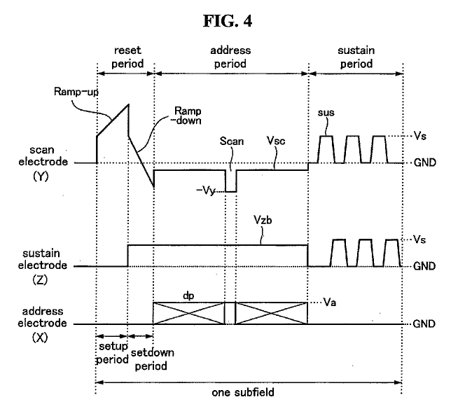

An example of an operation of a plasma display apparatus including a plasma display panel is described with reference to FIGS. 3 and 4. FIG. 3 is a diagram illustrating an example frame structure for expressing a gray level and FIG. 4 is a diagram illustrating examples of drive signals for driving a plasma display panel.

Referring to FIG. 3, a frame for expressing a gray level is divided into several subfields having different time durations of light emitting.

Further, although not shown, each subfield is again divided into a reset period for initializing all discharge cells, an address period for selecting a cell to be discharged, and a sustain period for generating sustain discharge to emit light.

For example, when an image is displayed with 256 gray levels, a frame period (16.67 ms) corresponding to 1/60 second is divided into, for example, 8 subfields (SF1 to SF8) as shown in FIG. 3, and each of 8 subfields (SF1 to SF8) is again divided into a reset period, an address period, and a sustain period.

By adjusting the number of sustain pulses supplied in a sustain period, a gray weight value of a corresponding subfield can be set. For example, a gray weight value of each subfield can be determined so that a gray weight value of each subfield increases with a ratio of 2ⁿ (n=0, 1, 2, 3, 4, 5, 6, 7), wherein the gray weight value of a first subfield is 2⁰, and the gray weight value of a second subfield is 2¹. By adjusting the number of sustain pulses supplied in a sustain period of each subfield according to a gray weight value in each subfield, various gray levels may be expressed.

FIG. 3 shows only a case where a frame includes 8 subfields. However, a frame may include a different number of subfields. For example, a frame may be formed with 12 subfields or with 10 subfields. The number of gray levels that can be expressed by a plasma display apparatus can be determined according to the number of subfields of a frame. For example, when the number of subfields of a frame is 12, 2¹² gray levels can be expressed, and when the number of subfields of a frame is 10, 2¹⁰ gray levels can be expressed.

In FIG. 3, in a frame, subfields are arranged in an increasing order of a gray weight value. However, in a frame, subfields may be arranged in a decreasing order of a gray weight value, or subfields may be arranged regardless of a gray weight value in order to prevent generation of contour noise on an image.

Referring to FIG. 4, an example of driving a plasma display panel is described. This exemplary driving technique may be applied to any subfields as shown in FIG. 3. In FIG. 1, each of the scan driver 200, the sustain driver 300, and the data driver 400 supplies a drive pulse to a scan electrode (Y), a sustain electrode (Z), and an address electrode (X) during at least one of a reset period, an address period, and a sustain period.

The reset period may be divided into a set-up period and a set-down period. The scan driver 200 can supply a rising pulse to the scan electrode (Y) during a set-up period.

A weak discharge is generated within discharge cells of the entire screen by the rising pulse. Hence, positive wall charges are stacked on the address electrode (X) and the sustain electrode (Z), and negative wall charges are stacked on the scan electrode (Y).

Further, the scan driver 200 can supply a falling pulse to the scan electrode (Y) during a set-down period which follows the set-up period. The falling pulse falls from a positive voltage level lower than the highest voltage of the rising pulse to a specific voltage level lower than the ground voltage level GND.

Accordingly, wall charges excessively formed within a discharge cell are fully erased by causing a weak erase discharge (i.e., a set-down discharge) within the discharge cells. Wall charges to stably generate an address discharge by the set-down discharge are uniformly remained within a discharge cell.

The sustain driver 300 supplies a sustain bias voltage Vzb to the sustain electrode (Z) during a set-down period and an address period. The sustain bias voltage Vzb can prevent an erroneous discharge.

Further, the scan driver 200 can supply a negative scan pulse falling from a scan bias voltage (Vsc) to a scan voltage (−Vy) in an address period. The scan bias voltage is lower than the ground voltage level GND.

The data driver 400 supplies a positive data pulse to the address electrode (X) while the scan pulse is supplied, if the cell corresponding to the scan electrode (Y) and the address electrode (X) is to emit light.

As a wall voltage generated in a reset period is added to a voltage difference between the scan pulse and the data pulse, an address discharge is generated within a discharge cell in which a data pulse is supplied. Wall charges to generate a discharge when supplying a sustain voltage Vs are formed within a discharge cell selected by an address discharge.

The scan driver 200 and the sustain driver 300 supply a sustain pulse SUS to the scan electrode (Y) and the sustain electrode (Z) in a sustain period after an address period. Accordingly, in a discharge cell selected by an address discharge, as a sustain pulse SUS is added to a wall voltage within the discharge cell, whenever each sustain pulse SUS is supplied, a sustain discharge is generated between the scan electrode (Y) and the sustain electrode (Z).

In such a driving method, an erasing period for removing remaining wall charges after a sustain discharge may be further added after a sustain period. Alternatively or additionally, a pre-reset period for stably forming wall charges in electrodes before a reset period may be further added.

In FIGS. 1 to 4, the scan driver 200 and the sustain driver 300 may be implemented in different circuits. Alternatively, the scan driver 200 and the sustain driver 300 may be implemented into a single circuit.

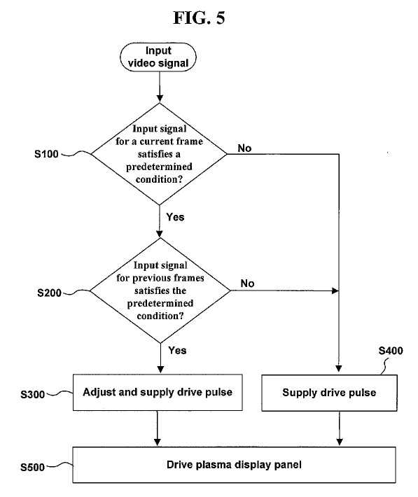

when the control unit 500 monitoring an input signal determines that the input signal for multiple frames satisfies a predetermined condition related to a brightness level of the frames, the scan driver 200, the sustain driver 300, and/or the data driver 400 adjust a drive pulse supplied to the plasma display panel, which is described with reference to FIGS. 5 to 13.

FIG. 5 is a flowchart illustrating an example method of driving a plasma display panel.

Referring to FIG. 5, a drive pulse supplied to a plasma display panel can be adjusted according to whether an input signal having a predetermined condition is included in video signals.

First, a video signal corresponding to a frame for displaying an image is supplied to the plasma display panel.

Thereafter, it is determined whether the video signal for a frame satisfies a predetermined condition related to a brightness level of a frame in step S100. The predetermined condition may be such that the brightness level for the video signal for a frame is less than a threshold level. For example, the predetermined condition may be such that the average brightness of all pixels of a frame is less than a first threshold, such as 10% of a highest possible brightness of a pixel. In another example, the predetermined condition may be such that the number of pixels in a frame having a brightness value greater than a second threshold (for example, 30% of the highest possible brightness of a pixel) is less than a third threshold (for example, 20% of the total number of pixels in the frame). These conditions may indicate a frame of low-gray level. These conditions may be applied independently or may be combined.

When it is determined that the video signal for a frame satisfies the predetermined condition at step S100, then it is determined whether video signals for other frames, for example, video signals for several previous frames, also satisfy the predetermined condition at step S200. For example, it is determined at step 200 whether video signals for a number of frames having a combined duration of 5 seconds or more satisfy the predetermined condition. Satisfaction of the predetermined condition for such a number of frames indicate that frames of low-gray level have been received, which also indicates that frames of low-gray level are likely to be received. In this document, therefore, satisfaction of the predetermined condition for a predetermined number of frames will be referred to as satisfying “the extended low-gray level condition”.

If the video signal for a frame does not satisfy the extended low-gray level condition, such as, for example, if any of the conditions at S100 and S200 is not satisfied, a drive pulse that is not adjusted is supplied to the plasma display panel in step S400. That is, a general drive pulse is supplied to the plasma display panel.

If the video signal satisfies the extended low-gray level condition, a drive pulse that is adjusted is supplied in step S300. Detailed description of the adjusted drive pulse is described later.

Adjusted or unadjusted drive pulse is supplied to the plasma display panel in step S500.

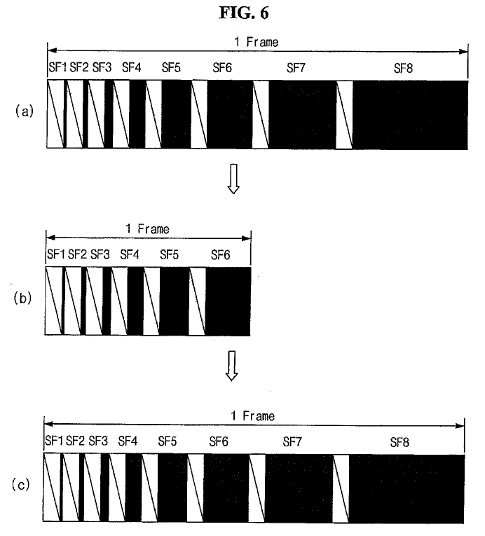

FIG. 6 is a diagram illustrating an example of frame structures.

Referring to FIG. 6, in an implementation, a frame for embodying a gray level can be divided into several subfields having the different number of times of light emitting.

FIG. 6(a) shows a subfield structure of a frame when the extended low-gray level condition is not satisfied, and FIG. 6(b) shows a subfield structure of a frame when the extended low-gray level condition is satisfied. As shown in FIGS. 6(a) and 6(b), the number of subfields for a frame is decreased when the extended low-gray level condition is satisfied. The reason why the number of subfields forming one frame is reduced is that the image of a low-gray level frame, which satisfies the extended low-gray level condition, can be expressed even with relatively less gray expression.

When the input signal for the next frame does not satisfy the extended low-gray level condition any more, then the number of subfields for the frame is returned to 8, as illustrated in FIG. 6(c).

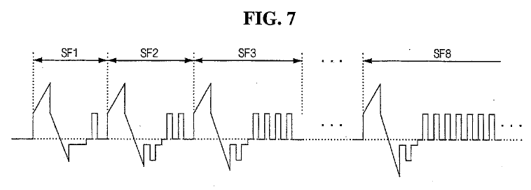

FIG. 7 is a diagram illustrating an example scan signal supplied to scan electrodes during subfields of a frame.

Referring to FIG. 7, a frame can be divided into several subfields having the different time durations of light emitting. Such a subfield structure is described in detail in FIG. 4 and therefore a detailed description thereof is omitted.

A drive pulse includes a scan signal. The scan signal includes a negative scan pulse falling from a scan bias voltage to a scan voltage in an address period. As a voltage difference of a data pulse and a wall voltage generated in a reset period are added to the scan pulse, an address discharge is generated within a discharge cell to which the data pulse is supplied. Wall charges to generate a discharge when a sustain voltage Vs is supplied are formed within a discharge cell selected by an address discharge.

When the extended low-gray level condition is satisfied, the drive pulse is adjusted such that no scan pulse is supplied to a scan electrode during an address period of at least one subfield.

By not supplying a scan pulse, an address discharge is not generated and thus a discharge cell is not selected by an address discharge. Therefore, even if a sustain voltage Vs is supplied to the scan and sustain electrodes during a sustain period after the address period, a sustain discharge is not generated. Accordingly, an erroneous discharge that can be displayed on a dark screen can be prevented and thus black contrast can be improved for a low-gray level image.

In FIG. 7, a scan pulse is omitted only in the first subfield, but a scan pulse can be omitted in one or more other subfields as well.

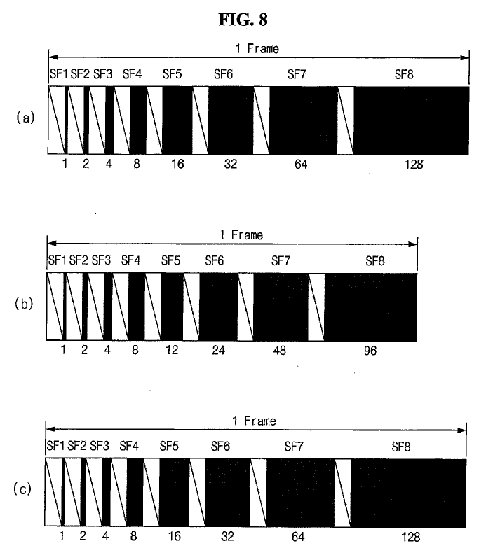

FIG. 8 is a diagram illustrating an example of adjusting frame structures depending on whether the extended low-gray level condition is satisfied.

Referring to FIG. 8, a case of adjusting the number of sustain pulses supplied in a sustain period of a subfield is described. FIG. 8(a) shows a frame structure before the extended low-gray level condition is satisfied, and FIG. 8(b) shows an adjusted frame structure when the extended low-gray level condition is satisfied.

In the frame structure of FIG. 8(b), that is, when the extended low-gray level condition is satisfied, the number of sustain pulses supplied to a scan electrode or a sustain electrode during a sustain period is decreased. The reason for decreasing the number of sustain pulses is that it is unnecessary to express certain gray levels in a low-gray level image. That is, a low gray-level image can be expressed even with relatively less gray expression.

Therefore, the number of sustain pulses supplied to a scan electrode or a sustain electrode during a sustain period among subfields described in FIG. 8(b) may be fewer than that of sustain pulses supplied to a scan electrode or a sustain electrode during a sustain period among subfields described in FIG. 8(a). By reducing the number of sustain pulses, power consumption can be saved.

FIG. 8(c) shows a frame structure when a received input signal does not satisfy the low-gray level condition anymore, and thus, the frame structure is not adjusted.

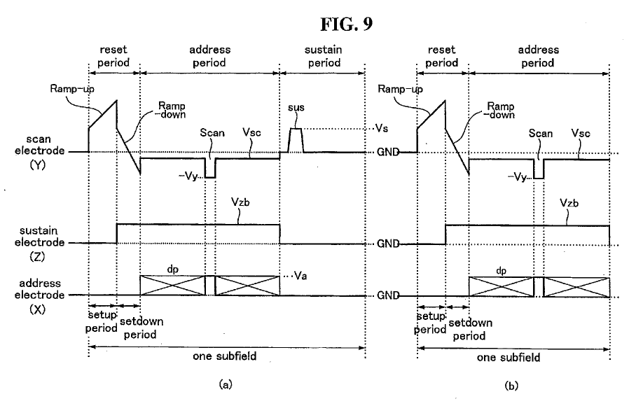

FIG. 9 is a diagram illustrating an example of driving signals in a subfield in which the number of sustain pulses are adjusted.

Referring to FIG. 9, when the extended low-gray level condition is satisfied, the number of sustain pulses may be adjusted.

For example, as represented by (a) in FIG. 9, only one sustain pulse may be supplied to a scan electrode and no sustain pulse may be supplied to a sustain electrode during a sustain period in one subfield. Accordingly, a discharge that can have an influence on gray expression during the subfield is an address discharge generated in an address period and a very weak sustain discharge generated by the one sustain pulse in a sustain period. Therefore, in addition to reducing power consumption, very minute expressions of gray level are possible.

In another example, as represented by (b) in FIG. 9, no sustain pulse is supplied at all during a subfield. In this case, a sustain period for supplying a sustain pulse is omitted and gray expression can be embodied through an address discharge only.

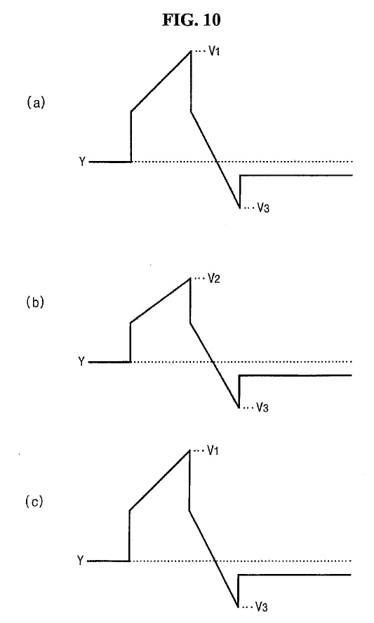

FIG. 10 is a diagram illustrating an example of adjusting reset pulses based on whether the extended low-gray level condition is satisfied. FIG. 10(a) shows a reset pulse supplied to a scan electrode (Y) in a reset period before the extended low-gray level condition is satisfied, and FIG. 10(b) shows an adjusted reset pulse when the extended low-gray level condition is satisfied.

As illustrated in FIGS. 10(a) and 10(b), the reset pulse includes a rising pulse and a falling pulse, and the highest voltage V2 of the rising pulse of the adjusted reset pulse supplied to a scan electrode (Y) when the extended low-gray level condition is satisfied is lower than the highest voltage V1 of the rising pulse of the unadjusted reset pulse supplied to a scan electrode (Y) before the extended low-gray level condition is satisfied.

The reason for lowering the highest voltage V2 of the rising pulse when the extended low-gray level condition is satisfied is to prevent deterioration of contrast characteristics as a dark screen becomes relatively light due to reset pulse light. An input signal satisfying the extended low-gray level condition indicates that a relatively dark image should be expressed. In this case, if an unadjusted reset pulse, such as the reset pulse in FIG. 10(a), is supplied, a relatively strong reset light is generated and thus contrast characteristics can be deteriorated. Therefore, by making a highest voltage of a rising pulse of a reset pulse relatively lower, as shown in FIG. 10(b), strong reset light is not generated and thus deterioration of contrast characteristics can be prevented.

Accordingly, a highest voltage V2 of a rising pulse of a reset pulse supplied to a scan electrode during a reset period shown in FIG. 10(b) is lower than a highest voltage V1 of a rising pulse of a reset pulse supplied to a scan electrode during a reset period shown in FIG. 10(a).

FIG. 10(c) shows an unadjusted reset pulse when an input signal for a frame no longer satisfies the extended low-gray level condition. In such a case, the waveform of the reset pulse returns to that of the reset pulse in FIG. 10(a).

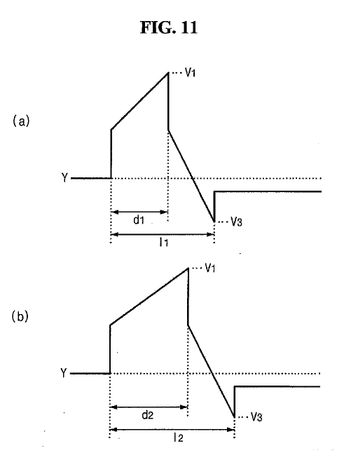

FIG. 11 is a diagram illustrating another example of adjusting reset pulses based on whether the extended low-gray level condition is satisfied.

FIG. 11(a) shows an unadjusted reset pulse supplied to a scan electrode in a reset period before the extended low-gray level condition is satisfied and FIG. 11(b) shows an adjusted reset pulses supplied to a scan electrode in a reset period when the extended low-gray level is satisfied. Compared to the example in FIG. 10 where the highest voltage of the rising pulse of a reset pulse is adjusted, the slope of the rising pulse of a reset pulse is adjusted in the example of FIG. 11.

A period d2 of a rising pulse supplied to a scan electrode in FIG. 11(b) is longer than a period d1 of a rising pulse supplied to a scan electrode in FIG. 11(a).

A period of a rising pulse is extended, that is, the slope of the rising pulse is decreased, to prevent deterioration of contrast characteristics. When an input signal satisfies the extended low-gray level condition, that is, when a relatively dark image should be expressed, by decreasing the slope of the rising pulse, strong reset light is not generated and thus deterioration of contrast characteristics can be prevented.

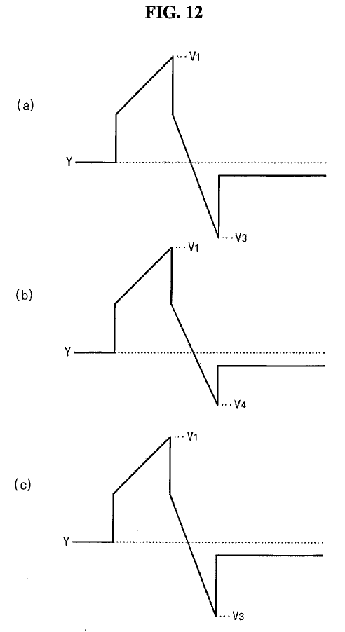

FIG. 12 is a diagram illustrating another example of adjusting reset pulses based on whether the extended low-gray level condition is satisfied.

FIG. 12(a) shows an unadjusted reset pulse supplied to a scan electrode in a reset period before the extended low-gray level condition is satisfied, and FIG. 12(b) shows an adjusted reset pulse supplied to a scan electrode in a reset period when the extended low-gray level condition is satisfied. In the reset pulse in FIG. 12(b), the lowest voltage of the falling pulse of a reset pulse is increased compared to the reset pulse in FIG. 12(a).

As shown in FIGS. 12(a) and 12(b), the lowest voltage V4 of a falling pulse supplied to a scan electrode when the extended low-gray level condition is satisfied is higher than the lowest voltage V3 of a falling pulse supplied to a scan electrode before the extended low-gray level condition is satisfied.

The reason of increasing the lowest voltage of a falling pulse is to prevent deterioration of contrast characteristics due to reset pulse light. When an input signal satisfying the extended lower-gray level condition is supplied, that is, when a relatively dark image should be expressed, if a lowest voltage of a falling pulse among reset pulses is as low as V3, strong reset light is generated and thus contrast characteristics can be deteriorated. Therefore, by making the lowest voltage of a falling pulse relatively high, deterioration of contrast characteristics can be prevented.

FIG. 12(c) shows an unadjusted reset pulse when an input signal does not satisfy the extended low-gray level condition any more. In such a case, the waveform of the reset pulse in FIG. 12(c) returns to that of the reset pulse in FIG. 12(a).

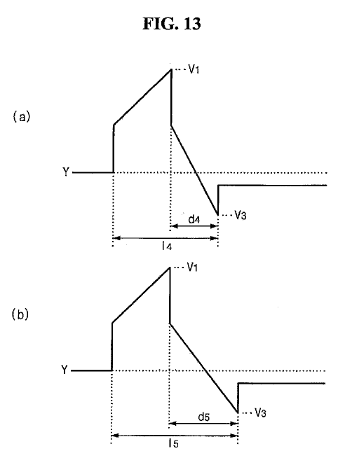

FIG. 13 is a diagram illustrating another example of adjusting reset pulses based on whether the extended low-gray level condition is satisfied.

FIG. 13(a) shows an unadjusted reset pulse supplied to a scan electrode in a reset period before the extended low-gray level condition is satisfied, and FIG. 13(b) shows an adjusted reset pulse supplied to a scan electrode in a reset period when the extended low-gray level condition is satisfied. In this example, the slope of the falling pulse of a reset pulse is adjusted when the extended low-gray level condition is satisfied.

As the slope of a falling pulse is adjusted, a period d5 of a falling pulse supplied to the scan electrode in FIG. 13(b) is longer than a period d4 of a falling pulse supplied to the scan electrode in FIG. 13(a).

The period of a falling pulse is extended to prevent deterioration of contrast characteristics. When an input signal satisfies the extended low-gray level condition, that is, when a relatively dark image should be expressed, by extending a falling period d5 of a falling pulse, that is, by adjusting the slope of a falling pulse, strong reset light is not generated and thus deterioration of contrast characteristics can be prevented.

In one implementation, the pairs of the sustain (Z) electrodes and scan (Y) electrodes are divided into a first electrode group and a second electrode group. The first electrode group may include odd-numbered electrode lines, and the second electrode group may include even-numbered electrode lines. The first electrode group includes scan electrodes to which the scan pulse is supplied temporally during the first half of the address period, and the second electrode group includes scan electrodes to which the scan pulse is supplied temporally during the second half of the address period. The electrodes may be divided into more than two electrode groups.

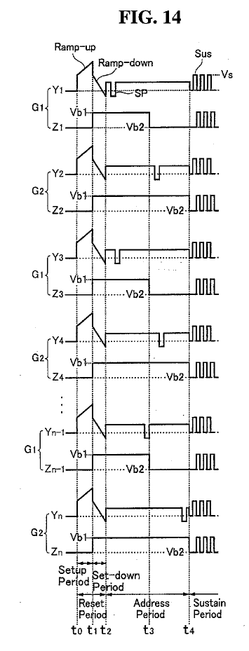

FIG. 14 shows an example waveform for driving the plasma display apparatus wherein the pairs of the sustain (z) electrodes and scan (Y) electrodes are divided into first and second electrode groups. Referring to FIG. 14, during the set-up period t0˜t1 of the reset period, sustain electrodes are sustained to the ground level, and the scan electrodes are supplied with a ramp-up pulse at the same time. During the set-down period t1˜t2 of the reset period, the sustain electrodes are supplied with a first bias voltage Vb1, and the scan electrodes are supplied with a ramp-down pulse at the same time.

Then, during the address period, sustain electrodes from the first electrode group Z1, 3, 5, . . . and sustain electrodes from the second electrode group Z2, 4, 6, . . . are supplied with different driving voltages.

In more detail, during the first half t2˜t3 of the address period, the sustain electrodes from the first electrode group Z1, 3, 5, . . . are sustained to the first bias voltage Vb1 and the scan electrodes from the first electrode group are supplied with the scan pulse Sp, so that an address discharge is performed. During the second half t3˜t4 of the address period, the sustain electrodes that form the first electrode group Z1, 3, 5, . . . are supplied with a second bias voltage Vb2 lower than the first bias voltage and the scan electrodes from the first electrode group are sustained to the scan bias voltage.

The sustain electrodes from the second electrode group Z2, 4, 6, . . . are supplied with the second bias voltage Vb2 during the first half t2˜t3 of the address period. After that, during the second half t3˜t4 of the address period, the scan electrodes from the second electrode group are supplied with the scan pulse Sp while the sustain electrodes from the second electrode group are supplied with the first bias voltage Vb1, so that address discharge is generated.

Thereafter, in the sustain period, the sustain pulse Sus is alternately applied to the whole scan electrodes and the whole sustain electrodes so that sustain discharge is generated.

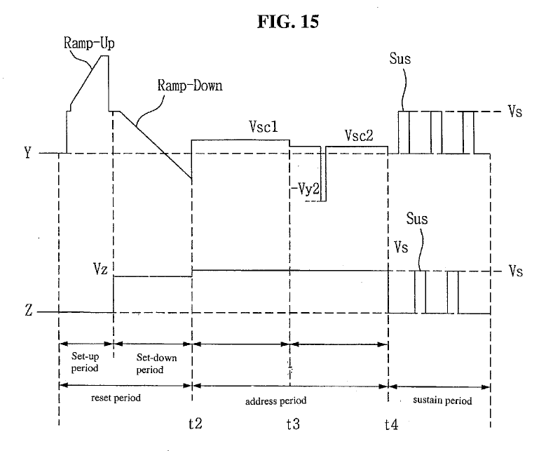

In the driving method as shown in FIG. 14, sustain electrodes in the first electrode group and the sustain electrodes in the second electrode group are driven by different bias voltages Vb1 and Vb2 during the address period. In another implementation, scan electrodes in the first electrode group and the scan electrodes in the second electrode group may be driven by different bias voltages. FIG. 15 shows an example waveform applied to one scan electrode. As shown in FIG. 15, for a scan electrode Y of one electrode group, bias voltage Vsc1 is applied during the first half of the address period and bias voltage Vsc2 is applied during the second half of the address electrode. For scan electrodes of the other electrode group, bias voltage Vsc2 is applied during the first half of the address period and bias voltage Vsc1 is applied during the second half of the address electrode

Other implementations are within the scope of the following claims.

What is claimed is:

1. A plasma display apparatus comprising:
a plasma display panel having a screen on which the plasma display panel displays an image;
a driver unit that supplies at least one drive signal to the plasma display panel; and
a control unit that monitors an input signal to the plasma display apparatus and controls the driver unit based on the monitored input signal,
wherein:
the input signal includes data arranged in frames;
the control unit is configured to provide the driver unit with a drive modification signal when the input signal for multiple frames is such that a brightness level for an image corresponding to each of the multiple frames is less than a threshold level; and
the driver unit is configured to adjust the drive signal supplied to the plasma display panel in response to the drive modification signal.

2. The plasma display apparatus of claim 1, wherein the multiple frames include a number of frames having a combined duration of 5 seconds or more.

3. The plasma display apparatus of claim 1, wherein each of the frames comprises multiple subfields, and the driver unit is configured to adjust a number of subfields of a frame in response to the drive modification signal.

4. The plasma display apparatus of claim 3, wherein the driver unit is configured to reduce the number of subfields of the frame in response to the drive modification signal.

5. The plasma display apparatus of claim 1, wherein the plasma display panel comprises at least one scan electrode, at least one sustain electrode and at least one address electrode, each of the frames comprises multiple subfields, each of the subfields comprises a reset period, an address period and a sustain period, and the driver unit is configured to adjust the drive signal in response to the drive modification signal so that at least one of the subfields includes an address period during which a scan pulse is not supplied to the at least one scan electrode.

6. The plasma display apparatus of claim 1, wherein the plasma display panel comprises at least one scan electrode, at least one sustain electrode and at least one address electrode, each of the frames comprises multiple subfields, each of the subfields comprises a reset period, an address period and a sustain period, and the driver unit is configured to adjust a number of sustain pulses supplied to the at least one sustain electrode or the at least one scan electrode during a sustain period of at least one subfield in response to the drive modification signal.

7. The plasma display apparatus of claim 6, wherein the driver unit is configured to reduce a number of sustain pulses supplied to the at least one sustain electrode or the at least one scan electrode during a sustain period of at least one subfield in response to the drive modification signal.

8. The plasma display apparatus of claim 1, wherein the plasma display panel comprises at least one scan electrode, at least one sustain electrode and at least one address electrode, each of the frames comprises multiple subfields, each of the subfields comprises a reset period, an address period and a sustain period, and the driver unit is configured to adjust a reset pulse supplied to the at least one scan electrode during a reset period of at least one subfield in response to the drive modification signal.

9. The plasma display apparatus of claim 8, wherein the driver unit is configured to adjust a highest voltage of the reset pulse supplied to the at least one scan electrode during the reset period of the at least one subfield in response to the drive modification signal.

10. The plasma display apparatus of claim 9, wherein the driver unit is configured to reduce the highest voltage of the reset pulse supplied to the at least one scan electrode during the reset period of the at least one subfield in response to the drive modification signal.

11. The plasma display apparatus of claim 8, wherein the driver unit is configured to adjust a lowest voltage of the reset pulse supplied to the at least one scan electrode during the reset period of the at least one subfield in response to the drive modification signal.

12. The plasma display apparatus of claim 11, wherein the driver unit is configured to increase the lowest voltage of the reset pulse supplied to the at least one scan electrode during the reset period of the at least one subfield in response to the drive modification signal.

13. The plasma display apparatus of claim 8, wherein the driver unit is configured to adjust a time duration of the reset period of the at least one subfield in response to the drive modification signal.

14. The plasma display apparatus of claim 1, wherein the control unit is configured to provide the driver unit with the drive modification signal when the input signal for multiple consecutive frames is such that a brightness level for an image corresponding to each of the multiple consecutive frames is less than a threshold level.

15. The plasma display apparatus of claim 1, wherein a brightness level for an image corresponding to a frame is less than the threshold level when an average brightness of all pixels of the frame is less than a first threshold.

16. The plasma display apparatus of claim 15, wherein the first threshold is 10% of a highest possible brightness of a pixel.

17. The plasma display apparatus of claim 1, wherein a brightness level for an image corresponding to a frame is less than the threshold level when a number of pixels in the frame having a brightness value greater than a second threshold is less than a third threshold.

18. The plasma display apparatus of claim 1, wherein the plasma display panel comprises a plurality of sustain electrodes, which are divided into sustain electrode groups, and wherein the driver unit is configured to apply, during a predetermined first period of an address period, a first sustain bias voltage to sustain electrodes of a first sustain electrode group and a second sustain bias voltage different from the first sustain bias voltage to sustain electrodes of a second sustain electrode group.

19. The plasma display apparatus of claim 1, wherein the plasma display panel comprises a plurality of scan electrodes, which are divided into scan electrode groups, and wherein the driver unit is configured to apply, during a predetermined first period of an address period, a first scan bias voltage to scan electrodes of a first scan electrode group and to apply a second scan bias voltage different from the first scan bias voltage to scan electrodes of a second scan electrode group.

20. A method of driving a plasma display panel which displays an image in response to at least one drive signal supplied to the plasma display panel, comprising:
receiving an input signal for multiple frames; and
adjusting the drive signal when the input signal for of the multiple frames is such that a brightness level for an image corresponding to each of the frames is less than a threshold level.

21. The method of claim 20, wherein the multiple frames include a number of frames having a combined duration of 5 seconds or more.

22. The method of claim 20, wherein each of the frames comprises multiple subfields, and wherein adjusting the drive signal includes adjusting a number of subfields of a frame.

23. The method of claim 20, wherein the plasma display panel comprises at least one scan electrode, at least one sustain electrode and at least one address electrode, each of the frames comprises multiple subfields, each of the subfields comprises a reset period, an address period and a sustain period, and adjusting the drive signal includes adjusting a number of sustain pulses supplied to the at least one sustain electrode or the at least one scan electrode during a sustain period of at least one subfield.

24. The method of claim 20, wherein the plasma display panel comprises at least one scan electrode, at least one sustain electrode and at least one address electrode, each of the frames comprises multiple subfields, each of the subfields comprises a reset period, an address period and a sustain period, and adjusting the drive signal includes adjusting a reset pulse supplied to the at least one sustain electrode during a reset period of at least one subfield.

25. The method of claim 20, wherein the multiple frames are consecutive frames.

26. The method of claim 20, wherein a brightness level for an image corresponding to a frame is less than the threshold level when an average brightness of all pixels of the frame is less than a first threshold.

27. The method of claim 20, wherein a brightness level for an image corresponding to a frame is less than the threshold level when a number of pixels in the frame having a brightness value greater than a second threshold is less than a third threshold.

28. The method of claim 20, wherein the plasma display panel comprises a plurality of sustain electrodes, which are divided into sustain electrode groups, and wherein the method further comprises, during a predetermined first period of an address period, applying a first sustain bias voltage to sustain electrodes of a first sustain electrode group and applying a second sustain bias voltage different from the first sustain bias voltage to sustain electrodes of a second sustain electrode group.

29. The method of claim 20, wherein the plasma display panel comprises a plurality of scan electrodes, which are divided into scan electrode groups, and wherein the method further comprises, during a predetermined first period of an address period, applying a first scan bias voltage to scan electrodes of a first scan electrode group and applying a second scan bias voltage different from the first scan bias voltage to scan electrodes of a second scan electrode group.
